(19) United States
(12) Patent Application Publication
(10) Pub. No.: US 2020/0047350 A1
(43) Pub. Date: Feb. 13, 2020

(54) COLLABORATIVE ROBOT

(71) Applicant: FANUC CORPORATION, Yamanashi (JP)

(72) Inventor: Takatoshi IWAYAMA, Yamanashi (JP)

(73) Assignee: FANUC CORPORATION, Yamanashi (JP)

(21) Appl. No.: 16/507,345

(22) Filed: Jul. 10, 2019

(30) Foreign Application Priority Data
Aug. 8, 2018 (JP) 2018-149481

(51) Int. Cl. B25J 13/08; B25J 19/00

(52) U.S. Cl. CPC B25J 13/085; B25J 19/002

(57) ABSTRACT

A robot where, irrespective of the position of the robot with which an operator comes into contact, the contact is more reliably detected, and a force applied to the operator is suppressed. Provided is a collaborative robot including: a wrist axis portion that determines the position of a tool mounted at a distal end thereof; and a basic axis portion that determines the position of the wrist axis portion and that is formed of only one or more linear-motion axes. The one or more linear-motion axes of the basic axis portion are each provided with a driving-force restricting unit that restricts a driving force so as to become equal to or less than a restriction value with respect to a related body area.

### CROSS-REFERENCE TO RELATED APPLICATIONS

This application is based on Japanese Patent Application No. 2018-149481, the contents of which are incorporated herein by reference.

### FIELD

The present invention relates to a collaborative robot.

### BACKGROUND

In the related art, there is a known 6-axis articulated collaborative robot (for example, see Publication of Japanese Patent No. 5980877 and Publication of US Patent Application No. 2013/0255426).

In the collaborative robot, an external force is detected by using a force sensor disposed at a lower section of the robot or a torque sensor disposed at each axis of the robot, and, when the detected external force exceeds a specified value, the robot is stopped.

### SUMMARY

According to one aspect, the present invention provides a collaborative robot including: a wrist axis portion that determines the position of a tool mounted at a distal end thereof; and a basic axis portion that controls the position of the wrist axis portion and that is formed of only one or more linear-motion axes, wherein the one or more linear-motion axes are each provided with a driving-force restricting unit that restricts a driving force so as to become equal to or less than a restriction value with respect to a related body area.

In the above-described aspect, the basic axis portion may be provided with: two horizontal linear-motion axes that extend in horizontal directions perpendicular to each other; and one vertical linear-motion axis that extends in a vertical direction.

In the above-described aspect, the vertical linear-motion axis may be provided with a counterbalancer.

In the above-described aspect, each of the one or more linear-motion axes may be provided with a motor that drives the linear-motion axis; and the driving-force restricting unit may be provided with: a torque detecting unit that detects a torque of the motor or a torque of an output axis; and a control unit that restricts a driving force of the linear-motion axis on the basis of the torque detected by the torque detecting unit.

In the above-described aspect, each of the one or more linear-motion axes may be provided with a motor that drives the linear-motion axis; and the driving-force restricting unit may be provided with: a force detecting unit that detects a driving force of the linear-motion axis; and a control unit that restricts the driving force of the linear-motion axis on the basis of the driving force detected by the force detecting unit.

In the above-described aspect, the driving-force restricting unit may be a mechanical clutch.

In the above-described aspect, the torque detecting unit may be multiplexed.

In the above-described aspect, the force detecting unit may be multiplexed.

In the above-described aspect, the mechanical clutch may be multiplexed.

### BRIEF DESCRIPTION OF DRAWINGS

FIG. 1 is a perspective view showing an example collaborative robot according to one embodiment of the present invention.

FIG. 2 is a schematic view for explaining a counterbalancer in a vertical linear-motion axis that is provided in the collaborative robot shown in FIG. 1.

FIG. 3 is a schematic view for explaining the operation of the counterbalancer shown in FIG. 2.

FIG. 4 is a perspective view for explaining a state in which the collaborative robot shown in FIG. 1 is disposed at one position within an operating region.

FIG. 5 is a perspective view for explaining a state in which the collaborative robot shown in FIG. 1 is disposed at another position within the operating region.

FIG. 6 is a schematic view showing a modification of the collaborative robot shown in FIG. 1.

FIG. 7 is a perspective view showing another modification of the collaborative robot shown in FIG. 1.

### DETAILED DESCRIPTION OF EMBODIMENTS

A collaborative robot 1 according to one embodiment of the present invention will be described below with reference to the drawings.

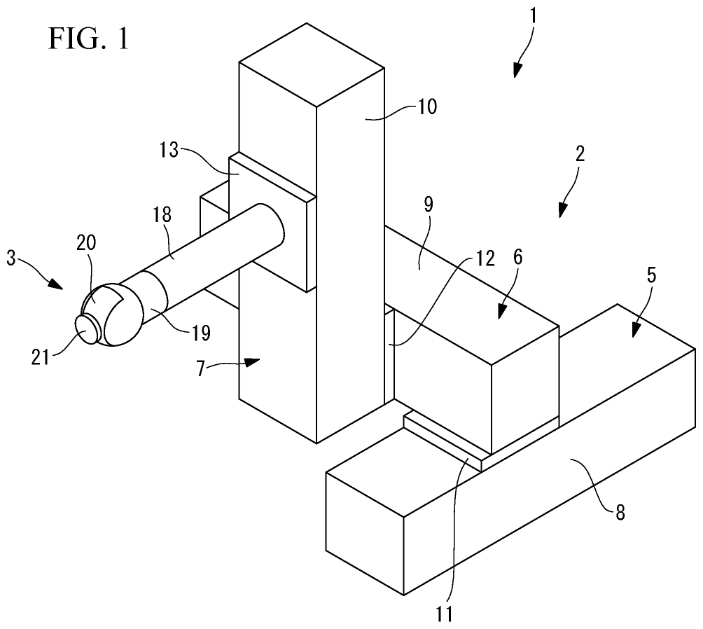

As shown in FIG. 1, the collaborative robot 1 of this embodiment is provided with a basic axis portion 2 and a wrist axis portion 3. The collaborative robot 1 is provided with a control unit (driving-force restricting unit) (not shown) that controls the basic axis portion 2 and the wrist axis portion 3.

The basic axis portion 2 is provided with: a first horizontal linear-motion axis (horizontal linear-motion axis, linear-motion axis) 5 that is installed on the floor surface; a second horizontal linear-motion axis (horizontal linear-motion axis, linear-motion axis) 6 that is moved in a first horizontal direction by the first horizontal linear-motion axis 5; and a vertical linear-motion axis (linear-motion axis) 7 that is moved in a second horizontal direction perpendicular to the first horizontal direction by the second horizontal linear-motion axis 6.

The first horizontal linear-motion axis 5, the second horizontal linear-motion axis 6, and the vertical linear-motion axis 7 are respectively provided with: rectangular-box-shaped bases 8, 9, and 10; and sliders 11, 12, and 13 that are supported so as to be movable with respect to the bases 8, 9, and 10 in the longitudinal-axis directions of the bases 8, 9, and 10. Linear-motion mechanisms that linearly move the sliders 11, 12, and 13 with respect to the bases 8, 9, and 10 and that are each provided with a motor and a ball screw (not shown) are provided inside the bases 8, 9, and 10.

Sensors (torque detecting units, force detecting units, driving-force restricting units) (not shown) that detect external forces applied to the sliders 11, 12, and 13 are respectively provided between: the sliders 11, 12, and 13 of the respective linear-motion axes 5, 6, and 7; and the bases 9 and 10 of the linear-motion axes 6 and 7 and the wrist axis portion 3, the bases 9 and 10 and the wrist axis portion 3 being connected to the sliders 11, 12, and 13, respectively.

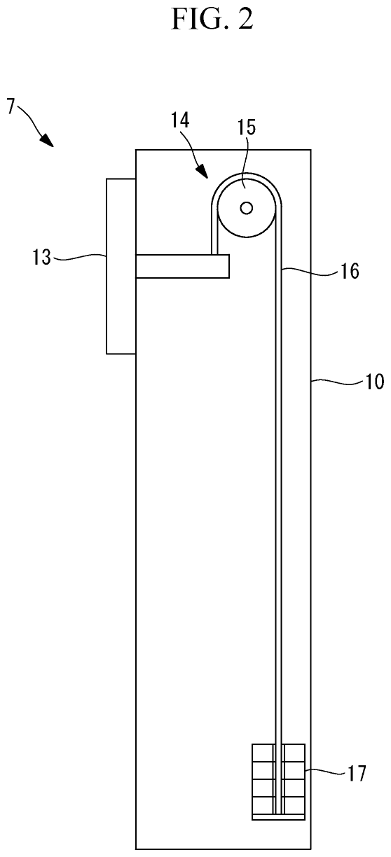

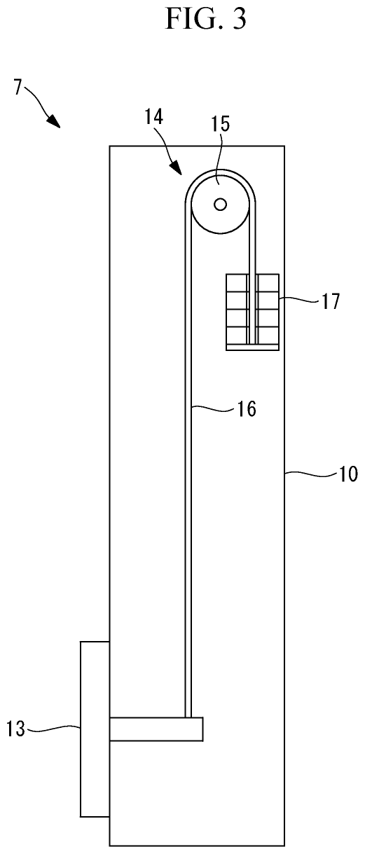

As shown in FIGS. 2 and 3, the vertical linear-motion axis 7 is provided with a counterbalancer 14 that produces a force for pulling the slider 13 upward, thus assisting the motor. In the example shown in FIGS. 2 and 3, the counterbalancer 14 is provided with: a pulley 15 that is attached to the base 10 so as to be rotatable; a wire 16 that is looped around the pulley 15 and one end of which is fixed to the slider 13; and a counterweight 17 that is supported at the other end of the wire 16. The weight of the counterweight 17 is half of the total weight of the slider 13, the wrist axis portion 3, and a tool mounted at a distal end of the wrist axis portion 3 or, if the tool is a hand or the like for gripping a workpiece, is half of the total weight of the slider 13, the wrist axis portion 3, the tool, and the workpiece.

The wrist axis portion 3 is provided with: a first wrist element 19 that is supported so as to be rotatable about a horizontal first axis with respect to a wrist body 18 fixed to the slider 13 of the vertical linear-motion axis 7; a second wrist element 20 that is supported so as to be rotatable about a second axis perpendicular to the first wrist element 19; and a third wrist element 21 that is supported so as to be rotatable about a third axis located in the same plane as the first axis. A tool (not shown) is fixed to the third wrist element 21.

The wrist axis portion 3 can freely adjust the orientation of the tool (not shown) mounted on the third wrist element 21, through rotation of the first wrist element 19 about the first axis with respect to the wrist body 18, rotation of the second wrist element 20 about the second axis with respect to the first wrist element 19, and rotation of the third wrist element 21 about the third axis with respect to the second wrist element 20.

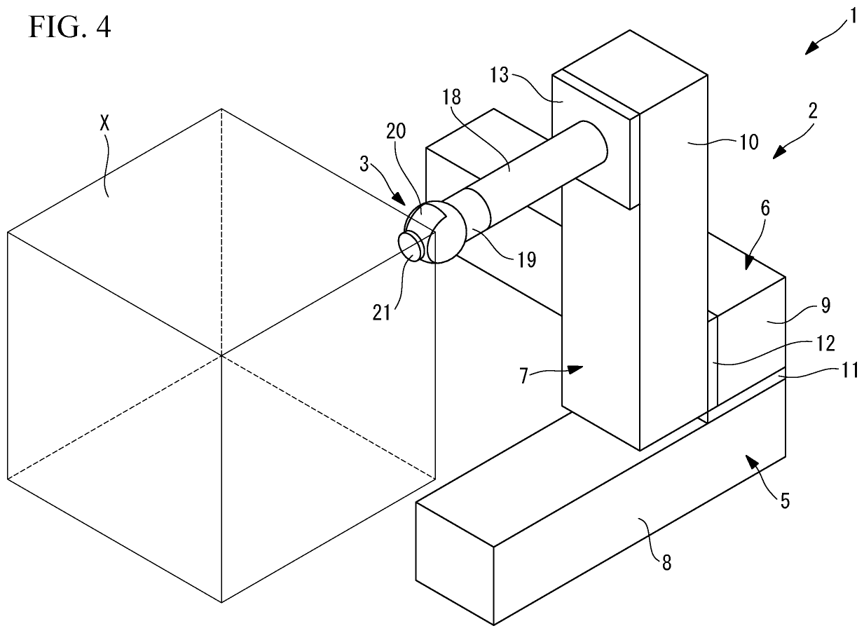

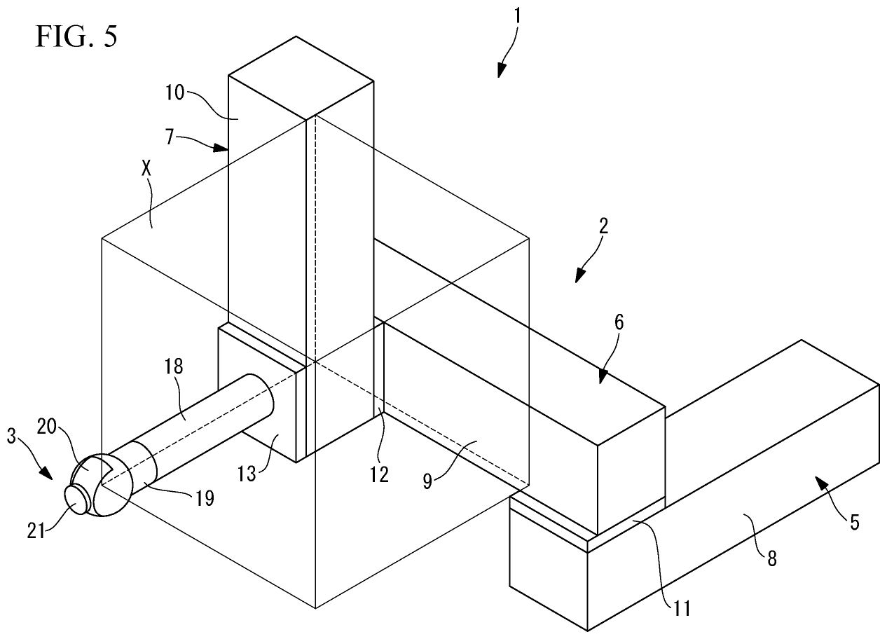

As shown in FIGS. 4 and 5, the position of the wrist axis portion 3 can be moved in a three-dimensional space through actuation of the basic axis portion 2. A cube shown in FIGS. 4 and 5 is an operating region X of the point of intersection (i.e., the wrist center) of the first axis, the second axis, and the third axis.

The control unit is constituted by a processor and a memory and supplies electric current for actuating respective motors in the basic axis portion 2 and the wrist axis portion 3 on the basis of a program stored in the memory. The control unit is provided with an electric-current detecting unit (torque detecting unit, force detecting unit, driving-force restricting unit) (not shown) that detects electric-current values supplied to the respective motors. It is possible to estimate external forces applied to the sliders 11, 12, and 13 on the basis of the electric-current values supplied to the motors in the basic axis portion 2.

The control unit restricts the electric-current values to be supplied to the motors on the basis of at least one of: the magnitudes of external forces estimated on the basis of the electric-current values detected by the electric-current detecting unit; and the magnitudes of external forces detected by the sensors.

Accordingly, external-force detection is multiplexed through detection of external forces by means of the sensors and estimation of external forces based on the electric-current values.

The control unit restricts the electric-current values such that driving forces of the sliders 11, 12, and 13 become equal to or less than the restriction value with respect to a related body area. Here, the restriction value with respect to a related body area indicates a limit value that should not be exceeded after a transient state produced when the industrial collaborative robot 1 comes into contact with an operator, and is specified in, for example, ISO/TS 15066: 2016 Appendix A, for each of human body parts with which the robot might come into contact.

In this embodiment, an abdominal muscle is adopted as a related body area that takes the smallest restriction value, and the control unit restricts the electric-current values so as to make driving forces of the sliders 11, 12, and 13 equal to or less than 110N, which is the restriction value with respect to the abdominal muscle. Accordingly, the driving forces are restricted so as to be less than a restriction value with respect to any of the other related body areas. It is of course possible to adopt an arbitrary restriction value with a risk taken into consideration, in accordance with the application of the collaborative robot 1.

The operation of the thus-configured collaborative robot 1 of this embodiment will be described below.

According to the collaborative robot 1 of this embodiment, the position of the wrist axis portion 3 in a three-dimensional space is determined through actuation of the three linear-motion axes 5, 6, and 7, which constitute the basic axis portion 2, and the position of the tool mounted on the third wrist element 21 is determined through actuation of the three wrist elements 19, 20, and 21, which constitute the wrist axis portion 3. Accordingly, it is possible to dispose the tool at a desired position and in a desired orientation within the operating region X, which is shown in FIGS. 4 and 5, and to perform work.

In this case, the magnitudes of external forces detected by the sensors provided on the three linear-motion axes 5, 6, and 7, which constitute the basic axis portion 2, and the electric-current values for the motors, which drive the linear-motion axes 5, 6, and 7, are continuously monitored. The control unit restricts the electric-current values such that the magnitudes of external forces that are detected by the sensors and the magnitudes of external forces that are estimated on the basis of the electric-current values for the motors all become equal to or less than 110N.

For example, if an operator comes into contact with the collaborative robot 1 during operation of the first horizontal linear-motion axis 5, thereby applying an external force to the collaborative robot 1, the electric-current value for the motor that actuates the first horizontal linear-motion axis 5 is increased; however, because the control unit restricts the electric-current value such that the driving force becomes equal to or less than 110N, it is possible to reliably prevent a force exceeding 110N from being applied to the operator. Because a force of 110N is the smallest force as the restriction value with respect to a related body area, there is an advantage in that it is possible to reliably suppress a force received by the operator so as to become equal to or less than the restriction value, regardless of the position of the related body area on the body of the operator.

In particular, in the collaborative robot 1 of this embodiment, because the three axes constituting the basic axis portion 2 are all formed of the linear-motion axes 5, 6, and 7, a force received by the operator is the same regardless of the position at which the force occurs on the linear-motion axes 5, 6, and 7. Therefore, there is an advantage in that, by restricting the driving forces of the linear-motion axes 5, 6, and 7, a force received by a human body due to insertion can be more reliably suppressed so as to become equal to or less than the restriction value.

In this embodiment, an external force received by each of the linear-motion axes 5, 6, and 7 is double-detected by the corresponding sensor and the electric-current detecting unit. Through multiplexing of detection, even if trouble occurs in one of the sensor and the electric-current detecting unit, there is an advantage in that it is possible to reliably detect or estimate an external force and to suppress a force applied to the operator so as to become equal to or less than the restriction value.

Multiplexing greater than twofold may be performed. Although multiplexing is attained by the sensors and the electric-current detecting unit, the sensors may be duplexed, or the electric-current detecting unit may be multiplexed by using a clamp meter or the like.

In this embodiment, although a driving force of 110N, which can be applied to all parts of the body, is set as the restriction value, by selecting an abdominal muscle as a related body area, if a part of the body of the operator that comes into contact with the collaborative robot 1 is limited, it is also possible to adopt the restriction value with respect to the limited part. For example, if a part of the body of the operator that comes into contact with the collaborative robot 1 is limited to a finger or an arm, as in a case in which a workpiece is handled on a table or other cases, it is possible to adopt 140N, which is the restriction value with respect to a finger. It is of course possible to adopt an arbitrary restriction value with a risk taken into consideration, in accordance with the application of the collaborative robot 1.

In this embodiment, although a description has been given of an example case in which, as the driving-force restricting unit, the control unit adjusts electric current for each of the motors on the basis of a detection result from the sensor or the electric-current detecting unit, thereby restricting the driving force, instead of this, it is also possible to adopt a mechanical clutch 22. The mechanical clutch 22 may be of a rotary type or a linear motion type.

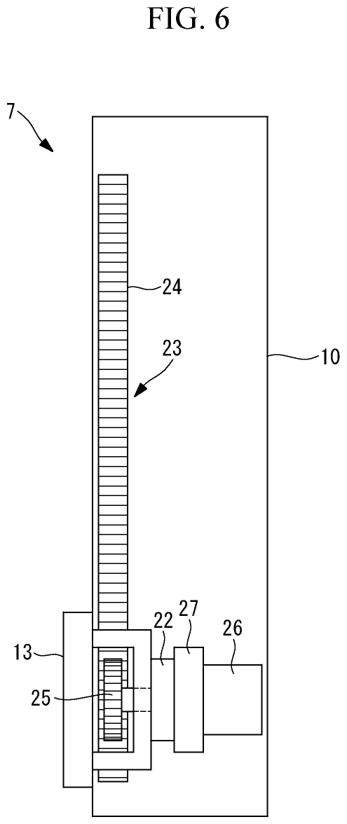

For example, as shown in FIG. 6, in a case in which a linear-motion mechanism 23 that linearly moves the slider 13 with respect to the base 10 is provided with: a rack gear 24 that is fixed to the base 10; and a pinion gear 25 that is engaged with the rack gear 24, the mechanical clutch (roller two-way clutch etc.) 22, which is of a rotary type, is disposed between a reducer 27 that reduces the speed of rotation of a motor 26 and the pinion gear 25. In FIG. 6, although the linear-motion mechanism 23 is explained by using the vertical linear-motion axis 7, the linear-motion mechanism 23 may also be applied to the other linear-motion axes 5 and 6.

An arbitrary type of the mechanical clutch 22 may be adopted as long as the mechanical clutch 22 blocks transmission of power of the motor to the corresponding one of the sliders 11, 12, and 13 when a driving force that exceeds the restriction value with respect to a related body area occurs. In this case, it is preferred that the mechanical clutch 22 be multiplexed.

In this embodiment, although a description has been given of an example structure in which, as the linear-motion axes 5, 6, and 7, the linear-motion mechanisms, which are each provided with a motor and a ball screw, linearly move the sliders 11, 12, and 13 with respect to the bases 8, 9, and 10, instead of this, it is also possible to adopt a structure in which the bases 8, 9, and 10 themselves slide in a telescopic manner in one direction or a structure that is of a pantograph type or that uses a pulley and a belt.

In this embodiment, because the counterbalancer 14 is provided in the vertical linear-motion axis 7, there is an advantage in that it is possible to suppress a driving force that can be produced by the motor of the vertical linear-motion axis 7, while securing the load capacity. In this case, the counterweight 17 can be varied in accordance with the weight of the tool and a workpiece. It is also possible to provide a sensor on the pulley 15, which is provided in the counterbalancer 14, to detect a failure of the pulley 15. Providing a mechanism for preventing a shake of the counterweight 17 is effective for stable operation of the collaborative robot 1. It is also possible to use a motor equipped with a brake, for the vertical linear-motion axis 7 and to use motors equipped with no brakes, for the first horizontal linear-motion axis 5 and the second horizontal linear-motion axis 6.

A tilt angle sensor for detecting an installation angle of the first horizontal linear-motion axis 5 may be provided in order to prevent a malfunction of the basic axis portion 2.

In a case in which a force that exceeds the restriction value is detected by the sensor, in a case in which a driving force that exceeds the restriction value is estimated on the basis of an electric-current value, or in a case in which transmission of power of the motor to the slider 11, 12, or 13 is blocked through actuation of the mechanical clutch 22, an alarm may be output to inform the outside.

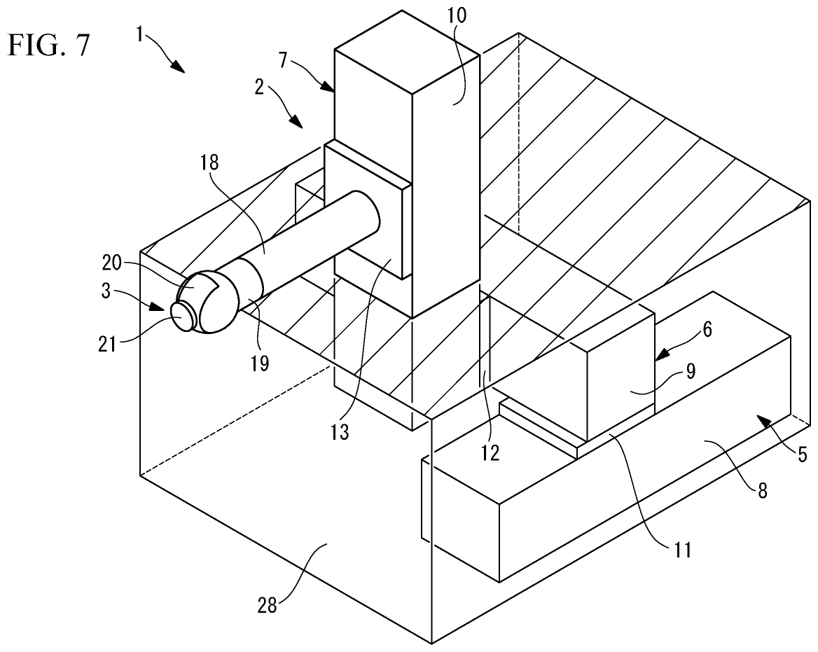

As shown in FIG. 7, it is also possible to provide a cover 28 for partially accommodating the basic axis portion 2, thereby reducing the likelihood of contact between the collaborative robot 1 and the operator and the occurrence of pinching or the like. In FIG. 7, a hatched section is a cover that prohibits the operator from inserting his/her fingers or arms while allowing two-dimensional horizontal movement of the vertical linear-motion axis 7, for example, with a combination of bellows, plates, or the like.

As a result, the following aspect is derived from the above described embodiment.

According to one aspect, the present invention provides a collaborative robot including: a wrist axis portion that determines the position of a tool mounted at a distal end thereof; and a basic axis portion that controls the position of the wrist axis portion and that is formed of only one or more linear-motion axes, wherein the one or more linear-motion axes are each provided with a driving-force restricting unit that restricts a driving force so as to become equal to or less than a restriction value with respect to a related body area.

According to this aspect, the position of the wrist axis portion in a space is determined through actuation of the basic axis portion, and the position of the tool mounted at the distal end is determined through actuation of the wrist axis portion. In this case, by actuating any one of the one or more linear-motion axes, which form the basic axis portion, it is possible to linearly move the wrist axis portion and the tool in one direction.

Even if insertion occurs between one linear-motion axis and an object during linear movement performed through actuation of the linear-motion axis, the driving-force restricting unit restricts the driving force so as to become equal to or less than the restriction value with respect to a related body area. The restriction value with respect to a related body area indicates a limit value that should not be exceeded after a transient state produced when an industrial collaborative robot comes into contact with an operator, and is specified in, for example, ISO/TS 15066: 2016 Appendix A, for each of human body parts with which a robot might come into contact.

In this case, according to this aspect, because the basic axis portion is formed of only the linear-motion axes, a force due to insertion occurring through actuation of each of the linear-motion axes is the same regardless of the position at which the force occurs on the linear-motion axis. Therefore, by restricting the driving force of the linear-motion axis, a force received by the human body due to the insertion can be more reliably suppressed so as to become equal to or less than the restriction value.

In the above-described aspect, the basic axis portion may be provided with: two horizontal linear-motion axes that extend in horizontal directions perpendicular to each other; and one vertical linear-motion axis that extends in a vertical direction.

With this configuration, the wrist axis portion can be disposed at an arbitrary position in a three-dimensional space through actuation of the basic axis portion.

In the above-described aspect, the vertical linear-motion axis may be provided with a counterbalancer.

With this configuration, due to the counterbalancer provided in the vertical linear-motion axis, which needs to vertically move the wrist axis portion etc. against gravity, it is possible to reduce the driving force required to raise the wrist axis portion etc. and to more reliably suppress a force due to insertion occurring when the wrist axis portion etc. is vertically moved, so as to become equal to or less than the restriction value.

In the above-described aspect, each of the one or more linear-motion axes may be provided with a motor that drives the linear-motion axis; and the driving-force restricting unit may be provided with: a torque detecting unit that detects a torque of the motor or a torque of an output axis; and a control unit that restricts a driving force of the linear-motion axis on the basis of the torque detected by the torque detecting unit.

With this configuration, the linear-motion axis is operated through actuation of the motor, thus moving a part mounted on the linear-motion axis, in one direction. In this case, the torque detecting unit detects the torque of the motor or the torque of the output axis, and the control unit can restrict the driving force of the linear-motion axis on the basis of the detected torque. For example, even when the torque of the motor, which drives the linear-motion axis, or the torque of the output axis is increased due to insertion or the like, the control unit restricts the driving force, thereby making it possible to more reliably suppress the force due to the insertion, so as to become equal to or less than the restriction value.

In the above-described aspect, each of the one or more linear-motion axes may be provided with a motor that drives the linear-motion axis; and the driving-force restricting unit may be provided with: a force detecting unit that detects a driving force of the linear-motion axis; and a control unit that restricts the driving force of the linear-motion axis on the basis of the driving force detected by the force detecting unit.

In the above-described aspect, the driving-force restricting unit may be a mechanical clutch.

With this configuration, the linear-motion axis is operated, thus moving a part mounted on the linear-motion axis, in one direction. In this case, even when the driving force for driving the linear-motion axis is increased due to insertion or the like, the drive system is detached by the mechanical clutch, thereby making it possible to more reliably suppress the force due to the insertion, so as to become equal to or less than the restriction value.

In the above-described aspect, the torque detecting unit may be multiplexed.

With this configuration, even when the torque cannot be detected due to a failure etc. of one torque detecting unit, the torque is detected by another torque detecting unit, thus making it possible to more reliably suppress the force due to insertion, so as to become equal to or less than the restriction value.

In the above-described aspect, the force detecting unit may be multiplexed.

In the above-described aspect, the mechanical clutch may be multiplexed.

With this configuration, even when the drive system cannot be detached due to a failure etc. of one mechanical clutch, the drive system is detached by another mechanical clutch, thus making it possible to more reliably suppress the force due to insertion, so as to become equal to or less than the restriction value.

1. A collaborative robot comprising:
a wrist axis portion that determines the position of a tool mounted at a distal end thereof; and
a basic axis portion that controls the position of the wrist axis portion and that is formed of only one or more linear-motion axes,
wherein the one or more linear-motion axes are each provided with a driving-force restricting unit that restricts a driving force so as to become equal to or less than a restriction value with respect to a related body area.

2. A collaborative robot according to claim 1, wherein the basic axis portion is provided with: two horizontal linear-motion axes that extend in horizontal directions perpendicular to each other; and one vertical linear-motion axis that extends in a vertical direction.

3. A collaborative robot according to claim 2, wherein the vertical linear-motion axis is provided with a counterbalancer.

4. A collaborative robot according to claim 1,
wherein each of the one or more linear-motion axes is provided with a motor that drives the linear-motion axis; and
the driving-force restricting unit is provided with: a torque detecting unit that detects a torque of the motor or a torque of an output axis; and a control unit that restricts a driving force of the linear-motion axis on the basis of the torque detected by the torque detecting unit.

5. A collaborative robot according to claim 1,
wherein each of the one or more linear-motion axes is provided with a motor that drives the linear-motion axis; and
the driving-force restricting unit is provided with: a force detecting unit that detects a driving force of the linear-motion axis; and a control unit that restricts the driving force of the linear-motion axis on the basis of the driving force detected by the force detecting unit.

6. A collaborative robot according to claim 1, wherein the driving-force restricting unit is a mechanical clutch.

7. A collaborative robot according to claim 4, wherein the torque detecting unit is multiplexed.

8. A collaborative robot according to claim 5, wherein the force detecting unit is multiplexed.

9. A collaborative robot according to claim 6, wherein the mechanical clutch is multiplexed.
